(19) United States
(12) Patent Application Publication
(10) Pub. No.: US 2010/0280632 A1
(43) Pub. Date: Nov. 4, 2010

(54) DEVICE FOR CONTROLLING THE FLOW OF A LIQUID AND METHOD USING SAID DEVICE

(76) Inventor: Olivier De Beaumarchais, Boulogne (FR)

Correspondence Address: FULBRIGHT & JAWORSKI, LLP, 666 FIFTH AVE, NEW YORK, NY, 10103-3198, US

(21) Appl. No.: 12/677,431

(22) PCT Filed: Jul. 23, 2008
(86) PCT No.: PCT/FR2008/001084

§ 371 Date: Jul. 15, 2010

(30) Foreign Application Priority Data
Aug. 10, 2007 (FR) 0757046

(51) Int. Cl. G05B 13/02; G01F 1/00; G06F 19/00

(52) U.S. Cl. 700/47; 702/45; 700/282

(57) ABSTRACT

The invention relates to a device and a method for controlling the flow of a liquid. In a learning phase, the flow rate of a liquid is measured for a given time period (t), the start and the end of this time period being indicated by a user. The value of the volume of liquid (V) dispensed during this time period is calculated from the duration (t) of the time period and from the flow rate measured during the time period, and this measured liquid volume value is stored as a reference value (V1-VN). Thus, during a use phase, the volume of liquid dispensed is measured, and when the value of the measured volume reaches the reference value (V1-VN), the flow of the liquid is shut off.

The invention relates to a device for controlling the flow of a liquid and a method using this device. The invention makes it possible to automatically shut off the flow of a liquid when a desired volume is reached, this volume having been previously “learned” by the device during a learning phase. In particular, the object of the invention is to fill a receptacle with liquid unattended.

The invention has a particularly advantageous, though not exclusive, application in the household sphere, for the filling of a bathtub or washbasin, a tank, a jerry can, or a drinking trough.

There is a known spray gun described in patent application EP-1655584, which makes it possible to calculate the quantity of water consumed during the spraying. However, it is necessary to know the precise value of the volume to be dispensed in order to obtain a desired amount of watering.

There are also known automatic watering devices that make it possible to water a garden at regular intervals (for example every day) for a length of time chosen by the user. However, such devices do not make it possible to guarantee that the same volume of water will be consumed from one watering to another. In reality, the rate of the flow can vary depending on, for example, the number of people drawing water from the system. If the flow rate is variable for a given watering time, the quantity of water will be different. The invention makes it possible to eliminate the flow rate variation factor by calculating the volume, thus making it possible to deliver a precise quantity of liquid.

The invention makes it possible to very precisely repeat the filling of a receptacle to a desired volume, without prior knowledge of the quantity of liquid to be poured into that receptacle and without having to monitor the filling.

To this end, during a learning phase, the user fills a receptacle while the device measures the volume of liquid consumed. When the level of liquid desired by the user is reached, the user operates the device so that the volume corresponding to this level is stored as a reference (set point) volume, inside the device.

Next, in a use phase, the device measures the dispensed volume and as soon as the value of the reference volume is reached, the device automatically cuts off the flow of water. Thus, the user will be able to repeat the filling of the receptacle, always to the same level (which corresponds to the reference volume stored in the learning phase) without having to monitor the flow of the liquid.

The setting of the reference volume is transparent for the user, who does not have to know in advance the volume of liquid that corresponds to the desired level. In fact, to configure the device, the user simply has to indicate the start and the end of the learning period corresponding to the moment at which the desired quantity of liquid has been dispensed, the reference volume being calculated, for example, from the flow measured during the learning phase and the duration of that learning phase.

Put differently, the object of the invention is a simple device, connected to a faucet or incorporated into it, which will first calculate the desired dispensed volume and store it, then by retrieving this dispensed volume value, cut off the supply when this volume value is reached, thus making it reproducibly possible to fill a receptacle unattended or to deliver a quantity of liquid that has been pre-calculated by means of this same device. This device, because it is simple to use, makes it possible to easily and quickly reproduce this measuring, storing and retrieval operation.

Of course, several reference volumes can be stored, these reference volumes being able to be associated with a user and/or a receptacle in order to facilitate their identification. For example, for a bathtub, a first reference volume can correspond to the filling volume of the bath for a baby, while a second reference volume can correspond to the filling volume of the bath for the parents. A third volume could, for example, correspond to the filling of another receptacle, such as a washbasin.

The device can also comprise a volume counter that measures the overall volume consumed since its last reset.

The device can also include partial counters associated with each of the stored reference volumes, these counters measuring the amounts of liquid consumed for in order to reach each of the reference values. Thus, it is possible to measure the consumption generated by each user (parents, baby) corresponding to each reference volume.

In a variant, the user will be able, using a display, to pre-indicate a known volume that will be dispensed as a reference volume.

The device is preferably connected to a liquid inlet channel by means of a swivel joint in order to make it possible to orient the stream of liquid emerging from the device. Moreover, in case of shock, the swivel joint prevents a rupture between the device and the channel, since it allows a relative movement of one with respect to the other.

For uses with a bathtub in a particular, the device is connected to an end of the faucet by means of a threading. Preferably, a set of threaded fittings is provided, so that the device can be adapted to several types of faucets. For outdoor uses, the device can be connected to watering hoses by means of conventional “Gardena” (registered trademark) connectors.

To connect the liquid inlet channel with the device, it is possible in a variant to use a universal fitting, for example made of rubber, which is adapted by compression to the liquid inlet channel.

The invention can also be used for watering, in which case the device controls the volume of water to be dispensed, for example in order to water a particular type of plant. In that case, it is no longer a matter of controlling the filling of a receptacle but of controlling the quantity of water dispensed so as to always have, no matter what the variations in flow, the same quality of watering.

The invention thus relates to a method for delivering a quantity of water which is not predetermined, but determined by learning using a device for controlling the flow of a liquid operated by a user, characterized in that it includes the following steps:

the step, for the user, of indicating the start and the end of a learning phase,

the step, for the device for controlling the flow of the liquid, of calculating a volume of liquid dispensed during the learning phase,

the step, for the device for controlling the flow of the liquid, of storing, as a reference value, the value of the volume of liquid calculated during the learning phase,

the step, for the device for controlling the flow of the liquid, during a use phase, of measuring a volume of liquid dispensed, and

the step, for the device for controlling the flow of the liquid, of shutting off the flow of the liquid when the value of the measured volume reaches the reference value that was calculated and stored during the learning phase,

so as to be able to reproducibly dispense, unattended, a volume of liquid pre-calculated during the learning phase.

According to one implementation, it includes the step, for the device for controlling the flow of the liquid, of calculating the value of the volume of liquid dispensed in the learning phase from the duration (t) of the learning phase and from the flow rate measured in said learning phase.

According to one implementation, it includes the step, for the device for controlling the flow of the liquid, of triggering an alarm when the reference volume is reached.

According to one implementation, it includes the step, for the device for controlling the flow of the liquid, of storing several reference values.

According to one implementation, it includes the step, for the device for controlling the flow of the liquid, of associating a label corresponding to a user with each of the stored reference volumes in order to facilitate their identification.

According to one implementation, it includes the step, for the device for controlling the flow of the liquid, of measuring the temperature of the liquid as it flows.

According to one implementation, it includes the step, for the device for controlling the flow of the liquid, of triggering an alarm when a temperature difference greater than a threshold value, for example 0.5 degree, is detected.

The invention also relates to device for controlling the flow of a liquid, characterized in that it includes:

an interface allowing a user to indicate the start and the end of a learning phase,

means for calculating the volume of liquid dispensed during said learning phase,

means for storing, as a reference volume, the value of the volume of liquid calculated during the learning phase, and

means for shutting off the flow of liquid when the value of the measured volume has reached the value of the reference volume that was calculated and stored during the learning phase,

so as to be able to reproducibly dispense, unattended, a volume of liquid that has been pre-calculated during the learning phase.

According to one embodiment, the means for calculating the reference volume include means for measuring said volume from the flow rate measured during the learning phase and from the duration of the learning phase.

According to one embodiment, it includes a generator/flowmeter installed in a channel disposed inside the device having a wall inside which flows a liquid, the generator/flowmeter comprising:

a rotary element installed in the channel driven in rotation by the flow of the water through the channel,

at least one magnet being attached to one of the surfaces of the rotary element,

a coil positioned outside the channel on the other side of the wall in line with the rotary element,

at least one ferrite associated with the coil and attached to the wall (47.1) being positioned so that the magnet or magnets (55) pass in proximity to them during the rotation of the wheel (49).

According to one embodiment, the rotary element is a helical rotary element capable of turning around an axis oriented in the direction of the extension of the channel.

According to one embodiment, the rotary element is a bladed wheel capable of turning around an axis oriented transversely with respect to the channel.

According to one embodiment, it is mounted in connection with a liquid outlet channel and includes a swivel joint fitting made to be connected to this liquid outlet channel, by screwing for example.

According to one embodiment, it is incorporated into a liquid outlet channel.

The invention will be better understood by reading the following description and examining the accompanying drawings. These figures are given merely as illustrations and do not in any way limit the invention. They show:

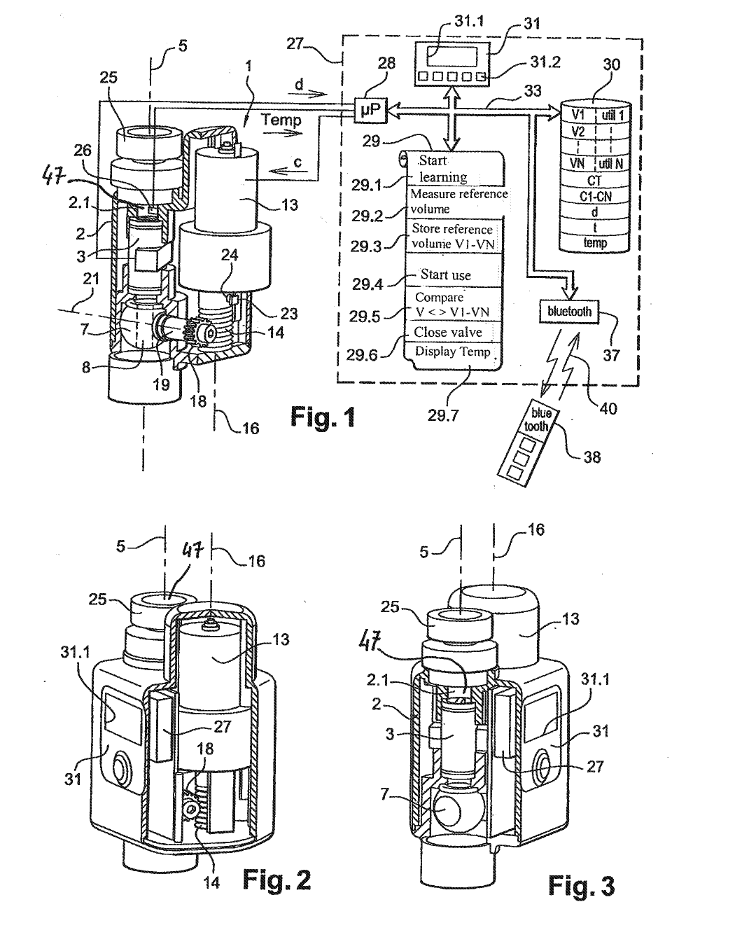

FIG. 1: a three-dimensional view of the liquid flow control device according to the invention accompanied by a schematic representation of its control unit;

FIGS. 2-3: three-dimensional representations of the inside of the device from two opposing angles of view;

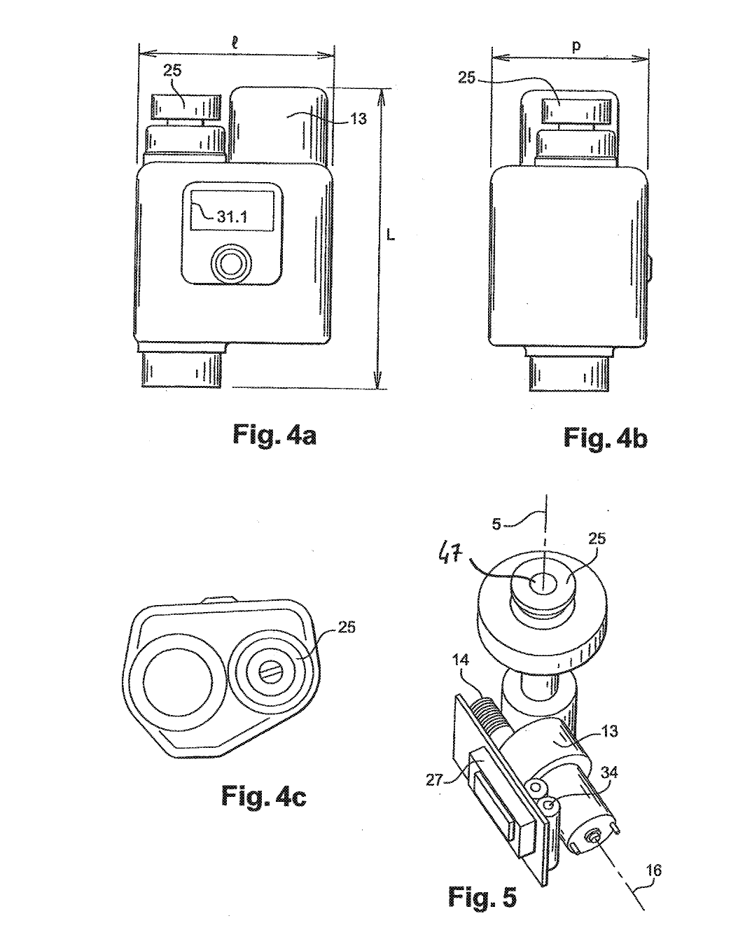

FIGS. 4a-4c: front, side and top views of the device according to the invention showing the dimensions of this device;

FIG. 5: a three-dimensional view of a horizontal architecture of the device according to the invention;

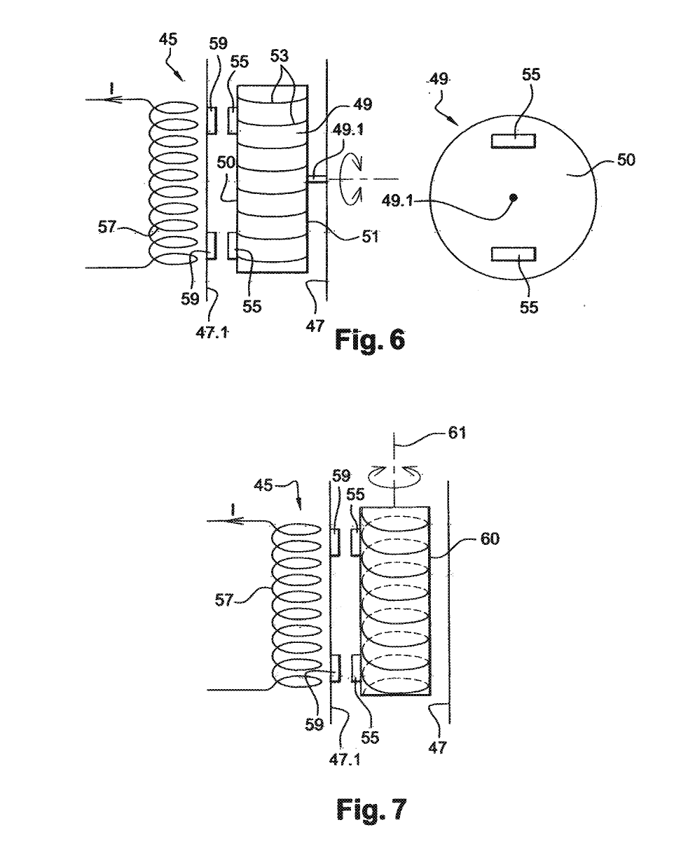

FIG. 6: a schematic representation of a first embodiment of a generator/flowmeter according to the invention and a side view of a bladed wheel it comprises;

FIG. 7: a schematic representation of a second embodiment of a of a generator/flowmeter according to the invention.

The identical elements retain the same references from one figure to another.

FIG. 1 shows a three-dimensional view of the liquid flow control device 1 according to the invention.

The device 1 includes a housing 2 inside which is disposed an opening 2.1 forming a channel 47 that extends along the prolongation of this housing. A tubular flowmeter 3 is positioned inside this opening 2.1, the wall of the flowmeter 3 cooperating in impermeable fashion with the walls of the opening 2.1. These elements 2, 3 have an axis 5 of symmetry along which the liquid flows through the device.

Positioned at the end of the flowmeter 3 is a ball-shaped valve 7 capable of allowing or blocking the passage of the liquid through the device 1. To this end, the valve 7 includes a passthrough cavity 8 that extends along the entire length of its diameter. When the cavity 8 is facing the opening 2.1 (valve in the open position), the liquid passes through the valve 7. Whereas when the solid wall of the valve 7 is situated facing the opening 2.1 (valve in the closed position), the liquid is blocked. To move from the open position to the closed position, it is sufficient to turn the valve 7 by a quarter turn.

For this purpose, the device 1 includes a motor 13, for example a DC motor, which drives a worm shaft 14 in rotation. The axis 16 of rotation of the motor 13 and of the shaft 14 is oriented parallel to the axis 5 of the device.

The shaft 14 cooperates with a toothed wheel 18 connected to the valve 7 by means of a transmission shaft 19. The axis 21 of rotation of the valve 7 and of the shaft 19 is perpendicular to the axes 5 and 16.

Thus, when it is actuated, the motor 13 turns the shaft 14, which transmits its rotational movement to the valve 7 via the wheel 18 and the shaft 19.

To detect the open or closed position of the valve 7, a position sensor 23 attached to the fixed housing of the motor 13 is preferably used. This sensor 23 is made to detect the position of a marker 24 attached to the screw 14. When the marker 24 is located in front of the sensor 23, the valve 7 is in the open position; whereas when the marker 24 is not located in front of this sensor 23 (the motor 13 having turned the valve by a quarter turn), the valve 7 is in the closed position (or vice versa).

The device 1 is connected to a liquid outlet channel (not shown) by means of a fitting 25, preferably forming a swivel joint between the device and the channel in order to limit the risk of rupture in case of shock. This fitting 25 can also be threaded so as to be adapted to a threading disposed for example in a bathtub faucet. In a variant, the device is incorporated into the liquid inlet channel.

The device 1 also includes a control unit 27 that includes a microprocessor 28, a program memory 29, a data memory 30 and a control interface 31 comprising, if necessary, a screen 31.1. These elements 28-31 are connected to each other by means of a communication bus 33.

In addition, the flowmeter 3 is connected to an input of the microprocessor 28 in order to transmit the value of the measured flow rate to this microprocessor 28. Whereas the motor 13 is connected to an output of the microprocessor 28, so that the microprocessor 28 can actuate the rotation of the motor 13.

In order to “teach” the device 1 the volume of liquid at which it must shut off the flow, the user operates the device via the interface 31 so as to execute the program 29.1, which starts the learning phase during which the valve 7 is in the open position. The start of this learning phase is, if necessary, indicated to the user by sound and/or light signal.

The user can then start the flow of liquid through the device 1, so that the flowmeter 3 measures the flow rate of the liquid dispensed and transmits the measured value d to the microprocessor 28, which stores it in the memory 30. When the desired quantity of water (the volume of which he does not know in advance) has been dispensed, the user indicates the end of the learning phase by again operating the interface 31. The duration t of the learning phase between the start and the end of the learning phase entered by the user is also stored in the memory 30.

By executing the program 29.2, the microprocessor 28 then calculates the volume V1 corresponding to the quantity of liquid dispensed during the learning phase, which is equal, for a constant flow rate, to the product of the flow rate d measured during the learning phase and the duration t of that learning phase. The formula is of course adapted when the flow rate varies during the learning phase, by integrating the flow rates with the time period in which they have been measured, for the entire learning phase.

During the execution of the program 29.3, the microprocessor 28 then records the measured volume V1 as a reference volume in the memory 30. In one embodiment, it is possible to store a user label “util1” or receptacle label to which this reference volume V1 corresponds.

Several reference volumes V1-VN corresponding to several users util1-utilN (or several receptacles) can be stored in the memory 30. In order to obtain each of these values V1-VN, a learning phase is executed. However, it would be possible to enter a reference volume V1-VN directly into memory when it is known.

During a use phase, the user selects the reference volume V1-VN corresponding to the desired filling level via the interface 31 or the desired label, and actuates the device so as to execute the program 29.4, which starts the use phase. The user can select the reference volume V1-VN directly or indirectly via the user label util1-utilN with which it is associated.

The controller 28 then indicates, if necessary, by means of a sound and/or light signal that it is ready for the filling, the valve 7 being in the open position.

The user can then start the flow of liquid, so that the microprocessor 28 measures the volume of liquid V dispensed by integrating the flow of liquid measured via the flowmeter with the time period in which it was measured. By executing the program 29.5, the microprocessor 28 compares the measured volume V with the reference volume V1-VN. When the volume of liquid dispensed V reaches the reference volume V1-VN, the controller 27 executes the program 29.6 and commands the motor 13 to set the valve 7 in the closed position.

The device then emits a light and/or sound signal to notify the user that the use cycle is finished.

The user can then turn off the device 1 and cut off the supply of liquid at the source, so that the valve 7 moves into the open position. In fact, preferably, the valve is set by default in the open position, so that when the device is shut off the liquid can pass through the device with no problem.

In one embodiment, a volume counter CT stores in memory 30 the overall volume of liquid consumed since its last reset. The device can also store in memory 30 partial counters C1-CN associated with each of the stored reference volumes V1-VN. These counters C1-CN store the consumption generated by each user util1-utilN corresponding to each reference volume V1-VN. The values of these counters CT, C1-CN can be displayed on the screen 31.1 at the request of the user.

In addition, the device 1 can include a temperature sensor 26 positioned inside the cavity 2.1 and connected to an input of the microprocessor 28. Thus, when the program 29.7 is executed, the temperature value Temp transmitted to the microprocessor 28 and stored in the memory 30 is displayed on the screen 31.1.

In one embodiment, a program is provided which triggers an alarm when a temperature difference greater than a threshold value, for example 0.5 degree, is detected.

The user communicates with the device via an audio or visual interface such as LEDs or a screen indicating information such as the volume (measured V or reference V1-VN or added CT, C1-CN) and/or the temperature and/or the user (util1-utilN).

The front view represented in FIG. 4a shows that the device has a length L of approximately 11 cm and a width I of approximately 7 cm. In addition, the side view represented in FIG. 4b shows that the device has a depth p of approximately 6 cm.

FIG. 5 shows a horizontal architecture of the device 1 wherein the axis of rotation 16 of the motor is perpendicular to the axis 5 of symmetry of the housing 2, the motor 13 in this case extending in a horizontal direction relative to the housing 2, which extends in a vertical direction.

The battery 34 that supplies power to the motor 13 is positioned behind the plate that carries the controller 27. In a variant, the battery 34 is replaced by a generator positioned inside the cavity 2.1, that transforms the energy from the flow of the liquid into electrical energy for powering the motor 13.

In addition, the device 1 according to the invention can be remotely controlled by a remote control 35 for initiating the learning and use phases. For this purpose, the controller 27 and the remote control 35 are each equipped with a bluetooth-type module 37, 38, which exchange data with each other via a radio link 40.

In a variant, the motor operates the valve 7 directly or is connected to this valve 7 by a set of conical gears.

In a variant, the ball-shaped valve 7 is replaced by any other type of valve capable of shutting off the flow of fluid, such as for example a flap valve.

FIG. 6 shows a schematic representation of a generator/flowmeter 45 according to the invention installed in a channel 47 having a wall 47.1 inside which flows a liquid. This generator/flowmeter 45 is installed in the channel 47 in place of the flowmeter 3, upstream from the closure system 7.

The element 45 includes a bladed wheel 49 installed in the channel 47. To this end, a rotating axle 49.1 of the wheel 49 transverse to the channel 47 is attached to the wall 47.1. This wheel 49 has two sides 50 and 51 between which are positioned blades 53, at least one magnet 55 being attached to one of the sides 50. In addition, a coil 57 is positioned outside the channel 47 on the other side of the wall 47.1 in line with the wheel 49. At least one ferrite 59 associated with the coil 57 can be embedded in or simply attached to the wall 47.1. This or these ferrites 59 are positioned so that the magnet or magnets 55 pass(es) in proximity to them during the rotation of the wheel 49.

Thus, when the liquid flows through the channel 47, it drives the wheel 49 in rotation and hence the magnet or magnets 55, which generate electrical pulses I to the terminals of the coil 57 as they pass in proximity to the ferrites 59. These pulses I are representative of the rotation speed of the wheel 49 and hence of the flow of the liquid through the channel 47.

The pulses I are transmitted to the control unit 27, which can count them over a period of time in order to deduce from them the value of the flow rate. By integrating the measured flow rate with a period of time, the volume of liquid that has been dispensed in that period of time is deduced.

In addition, the electric current corresponding to the pulses I can be used to power the various electrical components such as the control unit 27 or the motor 13 of the liquid flow control device 1 according to the invention. According to one embodiment, it is also possible to use a battery that will be recharged by the current generated by the element 45; however, this is optional.

In a variant, as represented in FIG. 7, the bladed wheel 49 is replaced by a helical element 60 having a helical groove on its external periphery capable of turning around an axis 61 that extends along the length of the channel as the liquid flows through the channel 47.

The magnet or magnets 55 in that case are attached to the external contour of the element 60, while the ferrites 59 associated with the coil 57 are still positioned on the wall 47.1 so that the magnet or magnets 55 pass(es) in proximity to them during the rotation of the wheel 49.

In the same way as above, the current corresponding to the pulses I generated in the terminals of the coil 57 can be used to power the electrical elements 13, 27 of the device and/or to calculate the flow rate of the liquid inside the channel. 47.

In a variant, the ferrites 49 are attached to the moving element 49, 60 while the magnets 55 are attached to the wall of the channel 47.

The flowmeter/generator 45 may be considered to be an entirely separate invention that can be used with devices other than the fluid control device according to the invention. The Applicant reserves the right to file a divisional application to protect its subject matter.

1-14. (canceled)

15. A method for delivering a quantity of liquid which is not predetermined, but determined by learning using a device for controlling the flow of a liquid operated by a user, comprising the steps of:
indicating a start and an end of a learning phase of the device by the user;
calculating a volume of the liquid dispensed during the learning phase by a processor of the device;
storing a value of the volume of the liquid calculated during the learning phase as a reference volume in a memory of the device by the processor;
measuring a volume of the liquid dispensed during a use phase of the device by the processor of the device; and
shutting off a flow of the liquid when a measured volume of the liquid reaches the reference volume by the device, thereby reproducibly dispensing, unattended, a volume of liquid which has been pre-calculated during the learning phase by the device.

16. The method of claim 15, further comprising the step of calculating the volume of the liquid dispensed in the learning phase from a duration of the learning phase and a flow rate measured in the learning phase by the processor of the device.

17. The method of claim 15, further comprising the step of triggering an alarm when the processor of the device determines that the measured volume of the liquid has reached the reference volume.

18. The method of claim 15, further comprising the step of storing a plurality of calculated values as reference volumes in the memory of the device.

19. The method of claim 18, further comprising the step of associating a label corresponding to the user with each reference volume stored in memory to facilitate identification of each reference volume.

20. The method of claim 15, further comprising the step of measuring a temperature of the liquid as it flows by a temperature sensor of the device.

21. The method of claim 20, further comprising the step of triggering an alarm when a difference in temperature measurements is greater than a threshold value.

22. Apparatus for controlling the flow of a liquid, comprising:
an interface to allow a user to indicate a start and an end of a learning phase;
a processor to calculate a volume of liquid dispensed during the learning phase;
a memory to store a value of the volume of the liquid calculated by the processor during the learning phase as a reference volume; and
a device for shutting off the flow of the liquid when a measured volume of the liquid reaches the reference volume, thereby reproducibly dispensing, unattended, a volume of liquid which has been pre-calculated during the learning phase.

23. The apparatus of claim 22, wherein the processor is operable to calculate the reference volume from a flow rate measured during the learning phase and from a duration of the learning phase.

24. The apparatus of claim 23, further comprising a generator/flowmeter installed in a channel disposed inside the apparatus having a wall, the liquid flowing inside the channel and wherein the generator/flowmeter comprising:
a rotary element installed in the channel rotationally driven by a flow of the liquid through the channel;
at least one magnet being attached to one of the surfaces of the rotary element;
a coil positioned outside the channel in line with the rotary element;
at least one ferrite, associated with the coil and attached to the wall, being positioned so that said at least one magnet pass in proximity to said at least one ferrite during the rotation of the rotary element.

25. The apparatus of claim 24, wherein the rotary element is a helical rotary element capable of turning around an axis oriented in the direction of the extension of the channel.

26. The apparatus of claim 24, wherein the rotary element is a bladed wheel capable of turning around an axis oriented transversely with respect to the channel.

27. The apparatus of claim 22 being mounted in connection with a liquid outlet channel and comprises a swivel joint fitting to connect the apparatus to the liquid outlet channel.

28. The apparatus of claim 22 being incorporated into a liquid outlet channel.
